(19) United States
(12) Patent Application Publication
(10) Pub. No.: US 2008/0147916 A1
(43) Pub. Date: Jun. 19, 2008

(54) DATA SYNCHRONIZATION METHOD OF DATA BUFFER DEVICE

(75) Inventor: Jin-Liang Mao, Fremont, CA (US)

Correspondence Address: KIRTON AND MCCONKIE, 60 EAST SOUTH TEMPLE,, SUITE 1800, SALT LAKE CITY, UT, 84111, US

(73) Assignee: VIA TECHNOLOGIES, INC., Taipei (TW)

(21) Appl. No.: 11/612,883

(22) Filed: Dec. 19, 2006

(51) Int. Cl. G06F 1/12; G06F 13/00

(52) U.S. Cl. 710/52

(57) ABSTRACT

In a data synchronization method for use in a multilane data buffer device including at least a first data buffer in a first lane and a second data buffer in a second lane, when there is a first invalid data transmitted in the first lane to be written into the first data buffer prior to a second invalid data transmitted in the second lane to be written into the second data buffer, a first synchronizing invalid data is written and inserted into the second data buffer. The first invalid data and the first synchronizing invalid data are written into the first data buffer and the second data buffer at synchronous positions. After the first synchronizing invalid data is written into the second data buffer, the second invalid data is discarded from entering the second data buffer.

### FIELD OF THE INVENTION

The present invention relates to a data synchronization method, and more particularly to a data synchronization method applied to a data buffer device. The present invention also relates to a data buffer device exhibiting a data synchronization function.

### BACKGROUND OF THE INVENTION

Multilane serial communication has been widely used in bus architecture of a computer system, e.g. PCI Express or Hyper Transport. Basically, for fixing a difference between a receiving recovery clock and a local clock, there is provided a buffer in a signal-receiving end. In addition, the buffer needs to exhibit a de-skew function for meeting a multilane protocol so as to generate and transmit lane-to-lane synchronized parallel data to a data link layer.

There are two conventional methods to implement the buffer for fixing the difference between a receiving recovery clock and a local clock. One is so called as a half-full method, and the other is so called as a flow control method.

The half-full method is usually adopted by PCI Express architecture for eliminating a difference between a receiving recovery clock and a local clock. In this method, extra special symbols, e.g. “COM” or “SKP”, are inserted in or discarded from the data so as to maintain the amount of data in the buffer at a proper level Generally, they occupy a half capacity of the buffer. Problems caused by different writing speed and reading speed of the buffer can thus be fixed.

An example of the half-full method will be described hereinafter with reference to FIG. 1(a). FIG. 1(a) exemplifies a four-lane data buffer device including buffers in lane 0, lane 1, lane 2 and lane 3, and illustrates special symbols inserted into the buffers and counting values generated according to the special symbols and recorded in the counters. In addition, offset values resulting from the counting values in the four lanes are recorded in an offset counter, and a COMDET signal is shown to indicate the occurrence of specified special symbols. It is to be noted that for facilitating illustration of the half-full method, data in the buffers are omitted from the drawing of FIG. 1(a), and only the inserted special symbols are shown, wherein symbols “S” and “C” represent “SKP” and “COM” mentioned above, respectively. In this example, the symbol “C” is always followed by three continuous symbols “S”. In addition to symbols “C” and “S”, symbols “CD” or “CA” are used to replace for the symbol “C” when there is difference existing between the receiving recovery clock and the local clock and required to be adjusted, wherein the symbol “CD” represents discarding a symbol “S” and the symbol “CA” represents inserting an extra symbol “S”. Therefore, the symbol “CD” will be followed by two continuous symbols “S” while the symbol “CA” will be followed by four continuous symbols “S”.

For meeting the requirements of multilane protocol, a de-skew function is necessary for the buffers. The algorithm for executing the de-skew function includes the following:

(i) recording the counting value in a counter as “2” when a symbol “C” is inserted into a corresponding buffer in a certain lane;
(ii) recording the counting value in a counter as “1” when a symbol “CA” is inserted into a corresponding buffer in a certain lane;
(iii) recording the counting value in a counter as “3” when a symbol “CD” is inserted into a corresponding buffer in a certain lane;
(iv) adding the counting value of a counter by 1 when a symbol “S” is inserted into a corresponding buffer in a certain lane;
(v) recording the minimum value among the four counting values simultaneously existing in the four lanes into the offset counter;
(vi) pulling the COMDET signal up to level “1” whenever any of the symbols “C”, “CA” and “CD” is detected in any of the four lanes, while pulling the COMDET signal down to level “0” when none of the symbols “C”, “CA” and “CD” is detected; and
(vii) subtracting the offset counting value from the counting values in the four lanes when the COMDET signal has remained at level “0” for a predetermined duration, as indicated by the dash line, so as to obtain respective latency offsets of the four lanes, as indicated by the rightmost column in FIG. 1(a).

By using the latency offsets, i.e. 2, 3, 1, 0, to make adjustment, the data in the buffers shown in FIG. 1(b) can be synchronized, as shown in FIG. 1(c).

Unfortunately, the above-described half-full method cannot be applied to all serial communication protocols. For example, it is not feasible for Hyper Transport. Instead of special symbols like “SKP”, a CRC timeslot (Cyclical Redundancy Check timeslot) is adopted for Hyper Transport. As known to those skilled in the art, the unitary length of a CRC timeslot is half-byte unit rather than byte unit, so to add or delete CRC timeslot inside the receiver buffer based on current buffer depth is impossible. Generally, CRC timeslot is required to be discarded before data pushing into the receiver buffer. Moreover, the half-full method suffers from long latency.

Nevertheless, the difference between a receiving recovery clock and a local clock for Hyper Transport can be eliminated in another way, i.e. the flow control method. A buffer is kept almost empty if the flow control method is adopted. It is understood that the buffer will remain empty if the local clock frequency is faster than the receiving recovery clock frequency, or some data in the buffer are discarded (i.e. in Hyper Transport, periodical CRC is discarded; in PCI Express, SKP is discarded) to maintain the empty feature if the local clock frequency is, on the other hand, slower than the receiving recovery clock frequency.

Although the flow control method is able to eliminate the difference between a receiving recovery clock and a local clock, unfortunately, lane-to-lane synchronization required for multilane protocol to achieve the de-skew purpose is infeasible because the buffer is emptied sometime.

### SUMMARY OF THE INVENTION

An embodiment of the present invention relates to a data synchronization method for a multilane data buffer device. The multilane data buffer device includes at least a first data buffer in a first lane and a second data buffer in a second lane. In the method, when there is a first invalid data transmitted in the first lane to be written into the first data buffer prior to a second invalid data transmitted in the second lane to be written into the second data buffer, a first synchronizing invalid data is written and inserted into the second data buffer. The first invalid data and the first synchronizing invalid data are written into the first data buffer and the second data buffer at synchronous positions. After the first synchronizing invalid data is written into the second data buffer, the second invalid data is discarded from entering the second data buffer.

According to another embodiment of the present invention, a data synchronization method for a multilane data buffer device including a plurality of data buffers in a plurality of lanes, respectively, includes steps of: writing and inserting a synchronizing invalid data into data buffers in the other lanes except the lane with the first invalid data at positions corresponding to the position of the first invalid data to be written into the data buffer in the first lane when a first invalid data is generated in any lane of the data buffer device; and discarding the first coming invalid data in each lane except the lane with the first invalid data; and clearing the empty state.

In a further embodiment, a multilane data buffer device includes a first data buffer in a first lane for receiving and buffering a first portion of a data; a second data buffer in a second lane for receiving and buffering a second portion of a data; and a controller coupled to the first data buffer and the second data buffer for having a first synchronizing invalid data written and inserted into the second data buffer when there is a first invalid data transmitted in the first lane to be written into the first data buffer prior to a second invalid data transmitted in the second lane to be written into the second data buffer, and having the second invalid data discarded from entering the second data buffer after the first synchronizing invalid data is written into the second data buffer.

### BRIEF DESCRIPTION OF THE DRAWINGS

The above contents of the present invention will become more readily apparent to those ordinarily skilled in the art after reviewing the following detailed description and accompanying drawings, in which:

FIG. 1(a) is a schematic diagram illustrating a four-lane buffer having a plurality of special symbols, four lane counters corresponding to the respective four lanes, a offset counter, and a COMDET signal diagram;

FIG. 1(b) is a schematic diagram illustrating asynchronous data in respective buffers of lane 0, lane 1, lane 2 and lane 3;

FIG. 1(c) is a schematic diagram illustrating data in respective buffers of lane 0, lane 1, lane 2 and lane 3 after synchronization;

FIG. 2 is a functional block diagram illustrating an embodiment of data buffer device according to the present invention;

FIG. 3 is a waveform diagram illustrating the offset compensation of the elastic buffers;

FIG. 4(a) is a waveform diagram illustrating a first example of de-skew operation according to an embodiment of the present invention;

FIG. 4(b) is a waveform diagram illustrating a second example of de-skew operation according to an embodiment of the present invention;

FIG. 5 is a flowchart illustrating a data synchronization method according to an embodiment of the present invention;

FIG. 6 is a waveform diagram illustrating the processing of packets transmitted to an upper data link layer; and

FIG. 7 is a functional block diagram illustrating another embodiment of data buffer device according to the present invention.

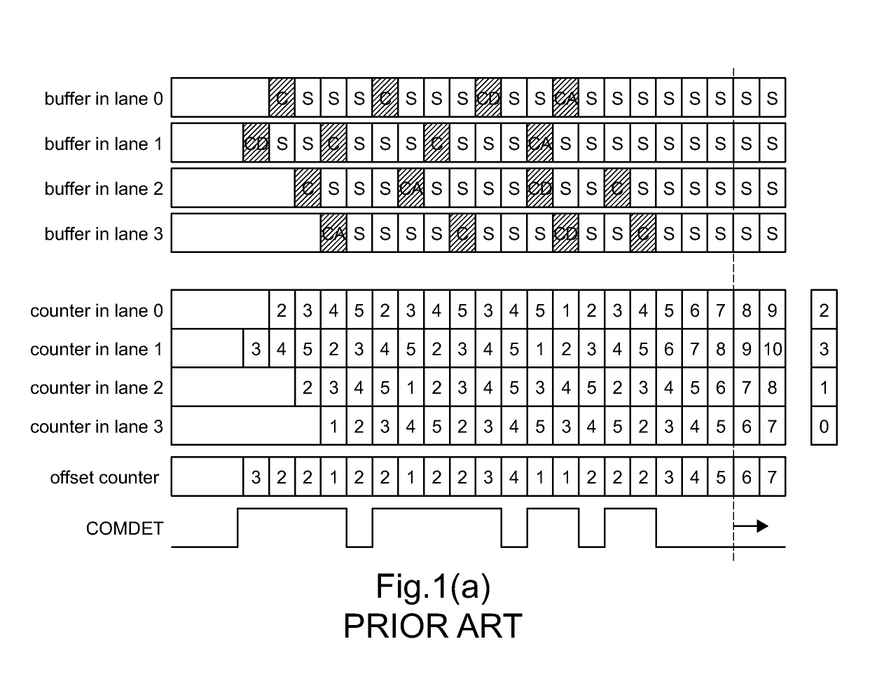

### DETAILED DESCRIPTION OF THE PREFERRED EMBODIMENT

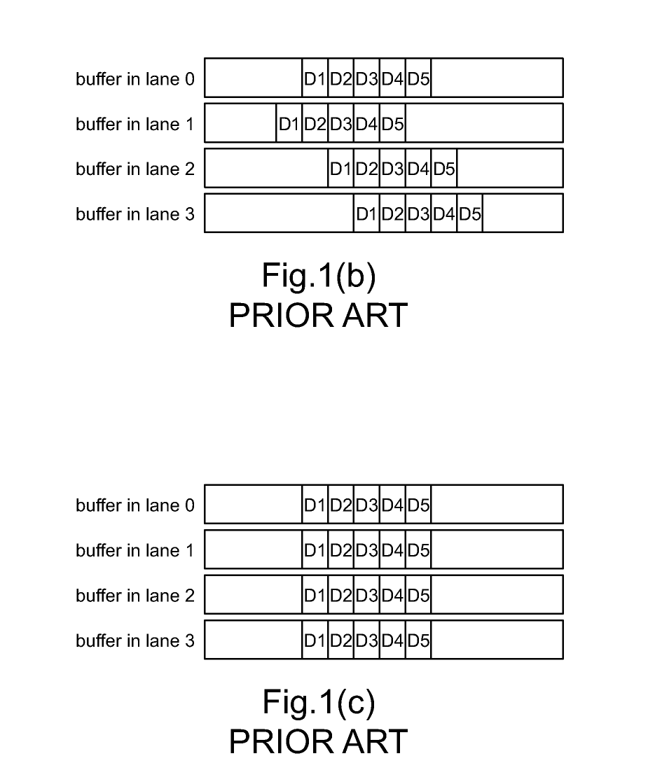

A data synchronization method applicable to multilane serial communication according to an embodiment of the present invention will be described hereinafter. By this method, the de-skew purpose can be achieved when a flow control method is adopted to eliminate the difference between a receiving recovery clock and a local clock. FIG. 2 exemplifies a two-lane communication architecture. It is understood that the example is given for illustration only, and it is not intended to be exhaustive or to be limited to the precise form disclosed. The data synchronization of the architecture involving more than two lanes can be accomplished in a similar fashion without redundantly repetitive illustration.

In a first lane, a first elastic buffer 20, a first de-skew buffer 22 and a first synchronized data buffer 24 are provided; and in a second lane, a second elastic buffer 21, a second de-skew buffer 23 and a second synchronized data buffer 25 are provided. Each of the elastic buffer 20 and 21 is a buffer disposed at a signal-receiving end for eliminating the difference between a receiving recovery clock and a local clock according to offset counting values. The de-skew buffers 22 and 23 are disposed downstream of the corresponding elastic buffers 20 and 21 for synchronizing data under the control of a controller 26, thereby generating lane-to-lane synchronized parallel data. The lane-to-lane synchronized parallel data are then outputted through the synchronized data buffer 24 and 25 to an upper data link layer.

According to the flow control method, periodical redundant data generated at the transmitting end, e.g. the periodical CRC codes, will be discarded after they are transmitted to the receiving end, so the elastic buffers will not be fully occupied in a normal condition.

On the condition that the elastic buffers are neither emptied nor fully occupied, the conventional synchronization method could still be used for the de-skew function among lanes. However, once any of the elastic buffers enters an empty state, invalid data will be transmitted to the upper data link layer when the flow control method is applied. Therefore, the present invention is developed to be capable of avoiding this problem.

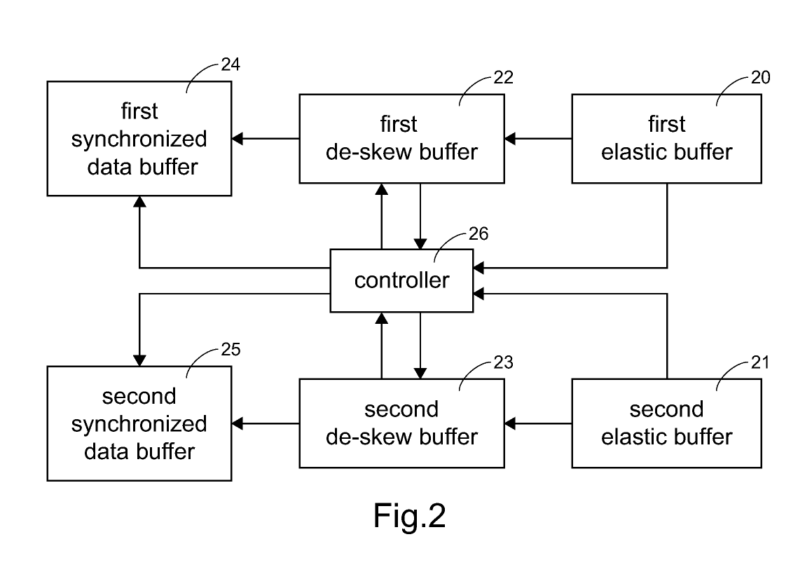

Please refer to FIG. 3, in which signals associated with the elements of FIG. 2 are shown for illustrating an embodiment of the data synchronization method according to the present invention.

As shown, after data A0, A1, A2 and A3 of the output DATA_00 are outputted in series from the first elastic buffer 20, the first elastic buffer 20 is empty. Therefore, in the present invention, an output pointer of the first elastic buffer 20 is frozen and the signal FROZEN_00 is pulled high for one cycle. Meanwhile, the out DATA_00 appearing in the first elastic buffer 20 contains invalid data “XX”. Likewise, after data B0, B1, B2 and B3 of the output end DATA_01 are outputted in series from the second elastic buffer 21, the second elastic buffer 21 is empty. Therefore, an output pointer of the second elastic buffer 21 is frozen and the signal FROZEN_01 is pulled high for one cycle. Meanwhile, the out DATA_00 appearing in the second elastic buffer 21 contains invalid data

In the present invention, to balance data rate between faster local clock and slower receiving recovered clock, the invalid data “XX” is treated of, for example, as a useful data “00”. Then the invalid data “00” and the following data of the DATA_00 (i.e. A4, A5 and A6) and DATA_01 (i.e. B4, B5, B6) are written into the first de-skew buffer 22 and the second de-skew buffer 23 in series.

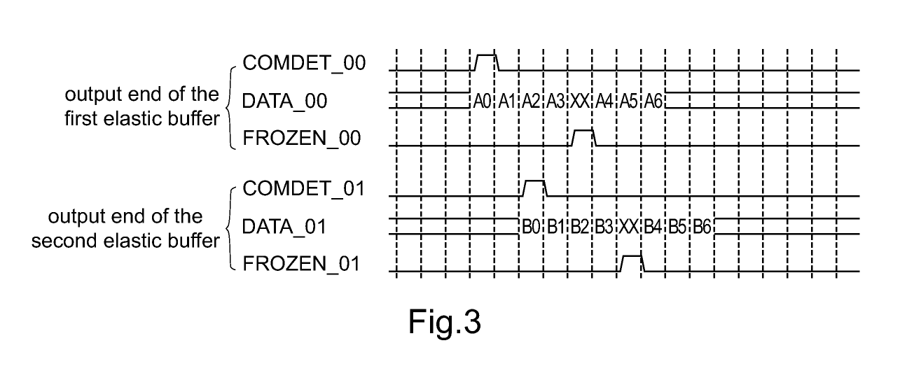

When the buffers of different lanes have the invalid data at different cycles, the output data of the de-skew buffers of lanes will have unsynchronized period when some lanes' buffers are empty and other lanes' buffers are not empty. The examples are illustrated in FIGS. 4(a) and 4(b).

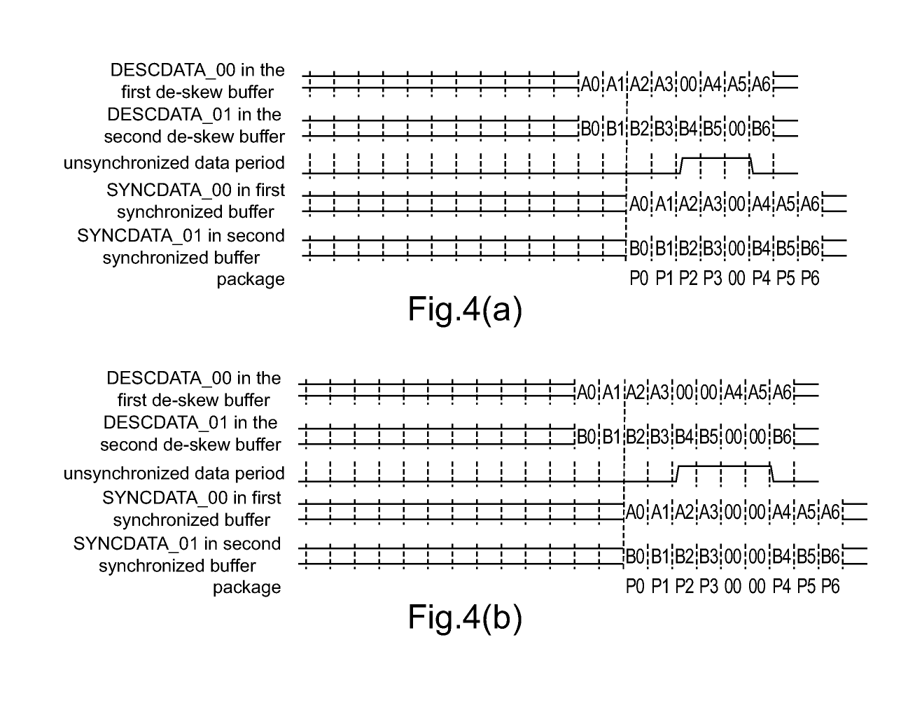

In the example of FIG. 4(a), the data “00” written in the first de-skew buffer 22 and that written in the second de-skew buffer 23 are asynchronous, as indicated by the DESCDATA_00 and DESCDATA_01 signals, respectively. When the data “00” is first detected to be written into the first synchronized data buffers 24, i.e. an empty state is detected by the controller 26, the controller 26 forcibly writes and inserts the same data “00” into the same position in the second synchronized data buffer 25, as indicated by the SYNCDATA_00 and SYNCDATA_01 signals. Next data “00” which is supposed to enter the second synchronized data buffer 25 following the data B5 will then be discarded. In this way, not only the valid data but also the invalid data can be synchronized. Likewise, as illustrated in another example of FIG. 4(b), the second occurrence of data “00” written in the first de-skew buffer 22 also results in the forcible recordation of data “00” in the second de-skew buffer 23 and the abandonment of both data “00” supposed to enter the synchronized data buffer 25 following the data B5, as indicated by the SYNCDATA_00 and SYNCDATA_01 signals. In this way, data synchronization can be achieved. Then, the synchronized data can be combined into packets P0, P1, . . . , to be outputted to the upper data link layer. Meanwhile, the preceding empty state is cleared, and the controller 26 detects whether there is any other empty state. A flowchart is given in FIG. 5 for summarizing an embodiment of the present synchronization method.

The present invention is particularly suitable for multilane serial communication bus architecture such as PCI Express or Hyper Transport bus architecture. In these architectures, the receiving recovery clocks used in the transmitting ends of all lanes are generated by the same phase locked loop (PLL) circuit. In addition, the local clocks used in the receiving ends of all lanes are generated by a common clock source. Accordingly, when the elastic buffer is empty or frozen, elastic buffer output data could be invalid. Therefore, the invalid output data is treated as an invalid data and transmitted like other useful data. Furthermore, when the empty is occurred in one lane, the empty will also occur in the other lanes sooner or later. Therefore, the invalid data “00” can be forcibly written and inserted into synchronized data buffers in the other lanes prior to the real occurrence of invalid data “00” in those lanes. Under this circumstance, a signal is pulled high when the first invalid data “00” first occurs in one lane, and then pulled low when the second invalid data “00” have occurred at least once for all lanes to indicate an unsynchronized data period.

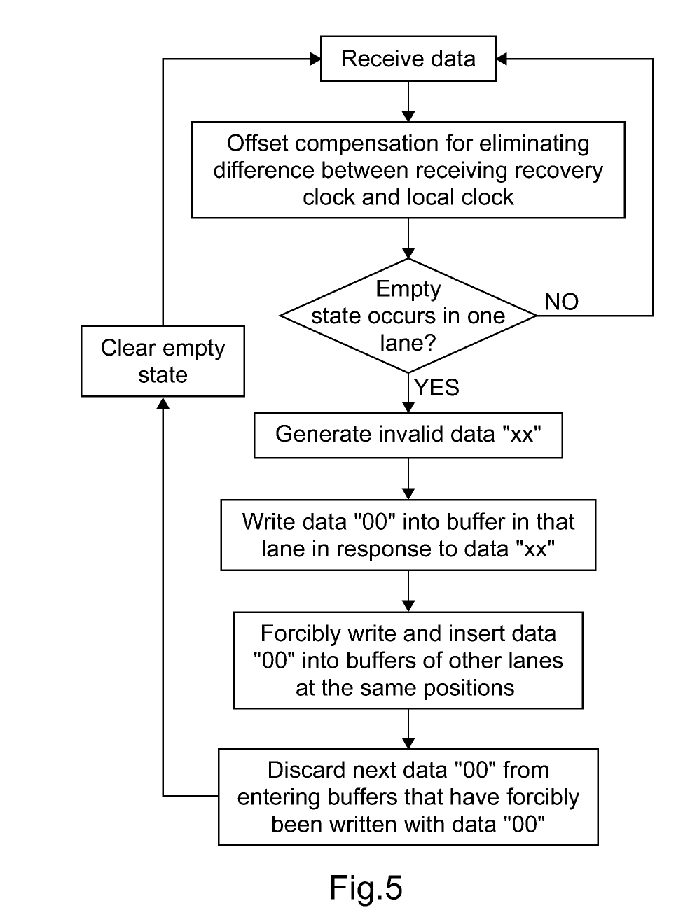

After the data packets are transmitted to the upper data link layer, the data link layer removes the invalid data “00” in the received packets and adds CRC codes to obtain effective CRC packets C0, C1, . . . , as shown in FIG. 6.

On the other hand, when one of the synchronized data buffers is emptied or become almost empty, the controller generates an INVALID_CYCLE signal, wherein

### INVALID_CYCLE=SYNC_0_EMPTY|SYNC_|_EMPTY|SYNC_2_EMPTY|SYNC_3_EMPTY,

where SYNC_*_EMPTY=1 indicates an empty condition of one of the synchronized data buffers.

In other words, the INVALID_CYCLE is pulled high when there is one of the synchronized data buffers empty or almost empty. Meanwhile, the read pointers for all synchronized data buffers will remain unchanged to have the synchronized data buffers output invalid data.

It is understood that the data buffer device according to the present invention may include more than two lanes although two lanes are exemplified above. Similar synchronization method as described above is applicable to the data buffer device including more than two lanes by forcibly writing and inserting invalid data “00” to synchronized data buffers in other lanes and then discarding the coming invalid data “00” when the data “00” is detected in one lane.

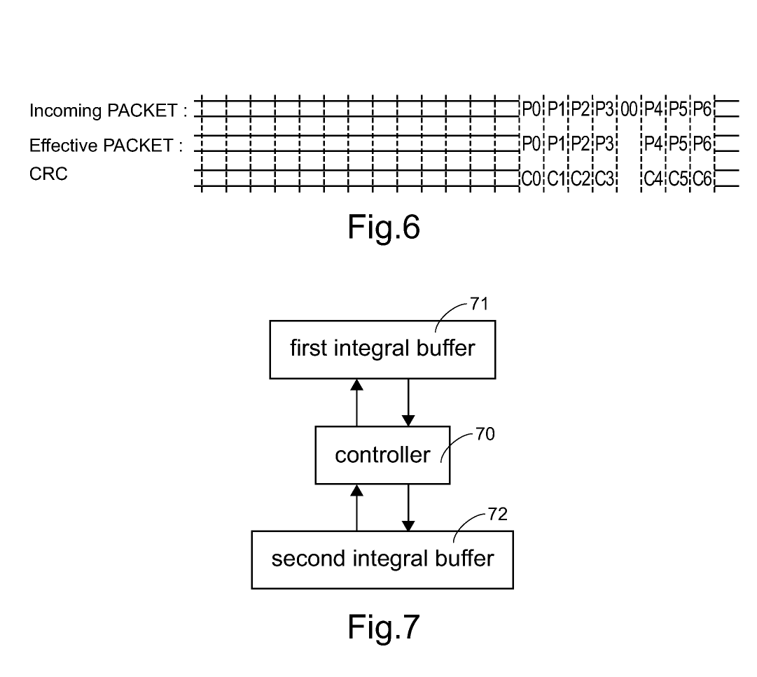

It is also understood that the elastic buffer, de-skew buffer and synchronized data buffer in the same lane can be combined as a single buffer, as illustrated in FIG. 7. The first integral buffer 71 and the second integral buffer 72 in the example of two-lane data buffer device are controlled by a controller 70 to achieve the purposes of offset compensation and de-skew in a manner similar to that mentioned above.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A data synchronization method for a multilane data buffer device, the multilane data buffer device having at least a first data buffer in a first lane and a second data buffer in a second lane, the method comprising:
writing and inserting a first synchronizing invalid data into the second data buffer when there is a first invalid data transmitted in the first lane to be written into the first data buffer prior to a second invalid data transmitted in the second lane to be written into the second data buffer; and
discarding the second invalid data from entering the second data buffer after the first synchronizing invalid data is written into the second data buffer,
wherein first invalid data and the first synchronizing invalid data are written into the first data buffer and the second data buffer at synchronous positions.

2. The method according to claim 1 further comprising steps of:
writing and inserting a second synchronizing invalid data into the first data buffer when there is a third invalid data transmitted in the second lane to be written into the second data buffer prior to a fourth invalid data transmitted in the first lane to be written into the first data buffer; and
discarding the fourth invalid data from entering the first data buffer after the second synchronizing invalid data is written into the first data buffer,
wherein the second synchronizing invalid data and the third invalid data are written into the first data buffer and the second data buffer at synchronous positions.

3. The method according to claim 1 wherein a valid data transmitted immediately next to the discarded second invalid data fills in the position of the discarded second invalid data to be written into the second data buffer so as to be synchronized with a valid data transmitted immediately next to the first invalid data.

4. The method according to claim 1 wherein the first synchronizing invalid data, the first invalid data and the second invalid data are identical.

5. The method according to claim 1 further comprising steps of:
switching an unsynchronized data period signal from a first level to a second level in response to the first invalid data; and
switching the unsynchronized data period signal from the second level to the first level in response to the second invalid data,
wherein the unsynchronized data period signal at the second level defines an unsynchronized data period, and the first synchronizing invalid data is written into the second data buffer and the second invalid data is discarded from the second data buffer within the unsynchronized data period.

6. The method according to claim 1 wherein the data buffer device further includes a third data buffer in a third lane, and the method further comprises steps of:
writing and inserting a third synchronizing invalid data into the third data buffer when the first invalid data is prior to a fifth invalid data transmitted in the third lane to be written into the third data buffer; and
discarding the fifth invalid data from entering the third data buffer after the third synchronizing invalid data is written into the third data buffer,
wherein the first invalid data, the first synchronizing invalid data and the third synchronizing invalid data are written into the first data buffer,
the second data buffer and the third data buffer at synchronous positions.

7. The method according to claim 1 further comprising steps of:
receiving a data according to a local clock, wherein the data is transmitted to the data buffer device according to a receiving recovery clock; and
adjusting the received data to eliminate a difference between the receiving recovery clock and the local clock.

8. The method according to claim 7 wherein the first invalid data and the second invalid data are generated in response to the adjustment of the received data.

9. The method according to claim 8 further comprising steps of:
entering the first lane an empty state when the first invalid data is generated; and
clearing the empty state after the first synchronizing invalid data is written into the second data buffer and the second invalid data is discarded.

10. A data synchronization method for a multilane data buffer device, the data buffer device having a plurality of data buffers in a plurality of lanes, respectively, and the method comprising steps of:
writing and inserting a synchronizing invalid data into data buffers in the other lanes except the lane with the first invalid data at positions corresponding to the position of the first invalid data to be written into the data buffer in the first lane when a first invalid data is generated in any lane of the data buffer device;
discarding the first coming invalid data in each lane except the lane with the first invalid data; and
clearing the empty state.

11. A multilane data buffer device, comprising:
a first data buffer in a first lane for receiving and buffering a first portion of a data;
a second data buffer in a second lane for receiving and buffering a second portion of a data; and
a controller coupled to the first data buffer and the second data buffer for having a first synchronizing invalid data written and inserted into the second data buffer when there is a first invalid data transmitted in the first lane to be written into the first data buffer prior to a second invalid data transmitted in the second lane to be written into the second data buffer, and having the second invalid data discarded from entering the second data buffer after the first synchronizing invalid data is written into the second data buffer.

12. The multilane data buffer device according to claim 11 wherein the first invalid data and the first synchronizing invalid data are written into the first data buffer and the second data buffer at synchronous positions under the control of the controller so that the first invalid data and the first synchronizing invalid data are combined as an invalid packet when outputted by the first data buffer and the second data buffer, respectively.

13. The multilane data buffer device according to claim 11 wherein a valid data transmitted immediately next to the discarded second invalid data fills in the position of the discarded second invalid data to be written into the second data buffer under the control of the controller so as to be synchronized and combined with a valid data transmitted immediately next to the first invalid data into a data packet.

14. The multilane data buffer device according to claim 11 wherein the first synchronizing invalid data, the first invalid data and the second invalid data are identical.

15. The multilane data buffer device according to claim 11 wherein the second data buffer includes:
an elastic buffer for receiving the second portion of the data according to a local clock, wherein the data is transmitted to the data buffer device according to a receiving recovery clock, and adjusting the received second portion of data to eliminate a difference between the receiving recovery clock and the local clock;
a de-skew buffer coupled to the elastic buffer for receiving the adjusted second portion of data including the second invalid data, and outputting a de-skew second portion of data including the first synchronizing invalid data but excluding the second invalid data; and
a synchronized data buffer coupled to the de-skew buffer for receiving the de-skew second portion of data and outputting the de-skew second portion of data to be combined with a de-skew first portion of data outputted by the first data buffer.

16. The multilane data buffer device according to claim 15 wherein each of the first data buffer and the second data buffer is a single data buffer.

17. The multilane data buffer device according to claim 11 being used in a PCI Express bus architecture.

18. The multilane data buffer device according to claim 11 being used in a Hyper Transport bus architecture.
